(19) United States
(12) Patent Application Publication
(10) Pub. No.: US 2023/0407043 A1
(43) Pub. Date: Dec. 21, 2023

(54) SILVER IMPREGNATED THERMOPLASTIC ELASTOMER DEVICES AND METHODS OF MANUFACTURE THEREOF

(71) Applicant: Joseph M. O'Connor, Meriden, CT (US)

(72) Inventor: Joseph M. O'Connor, Meriden, CT (US)

(21) Appl. No.: 17/807,048

(22) Filed: Jun. 15, 2022

(51) Int. Cl. C08K 3/08; A63H 3/36; A61H 19/00

(52) U.S. Cl. CPC C08K 3/08; A63H 3/36; A61H 19/50; A61H 19/32; C08K 2003/0806

(57) ABSTRACT

Devices that include one or more contact surfaces formed from a silver impregnated thermoplastic elastomer material are herein disclosed. These devices can take various forms, and the portions formed from the silver impregnated thermoplastic elastomer prevent growth of bacteria, mold, and other harmful organisms. Associated methods of manufacturing such devices are also herein disclosed.

### BACKGROUND OF THE INVENTION

The present invention relates to adult devices and, more particularly, to the impregnation of a thermoplastic elastomer-based adult device with silver to prevent bacteria buildup.

Adult devices exist in many forms to provide sexual pleasure to the user thereof. Examples of adult devices include, but are not limited to, sex dolls and vibrators. A ‘sex doll’ is a human-like, full-body, anatomically correct anthropomorphic doll of one or more selected materials that is designed for sexual use.

It has become common to use thermoplastic elastomers (TPE) in adult devices, such as sex dolls, as it is a softer, cheaper material than silicone. However, it is porous, more difficult to clean, and impossible to sterilize.

As can be seen, there is a need for a TPE-based adult device as detailed herein

### SUMMARY OF THE INVENTION

In one aspect of the present invention, an adult device is disclosed that includes a first contact surface portion that is formed from a silver impregnated thermoplastic elastomer material.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention;

FIG. 2 is a side view of the embodiment of the present invention;

FIG. 3 is a section view of the embodiment of the present invention, taken along line 3-3 in FIG. 2; and

FIG. 4 is a flow chart of a manufacturing process in accordance with the present invention.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured

Broadly, one embodiment of the present invention is an adult device that includes at least one portion formed from TPE impregnated with silver. The resulting composite prevents bacteria buildup and greatly reduces the risk of buildup of other undesired organisms, such as mold. TPE-based adult devices with silver impregnated therewithin will greatly reduce health issues associated with insufficiently cleaning, maintaining, and/or drying the adult devices after each use. Thus, the lifespan of the devices can be increased while reducing the sanitization time needed to ensure it remains safe to use.

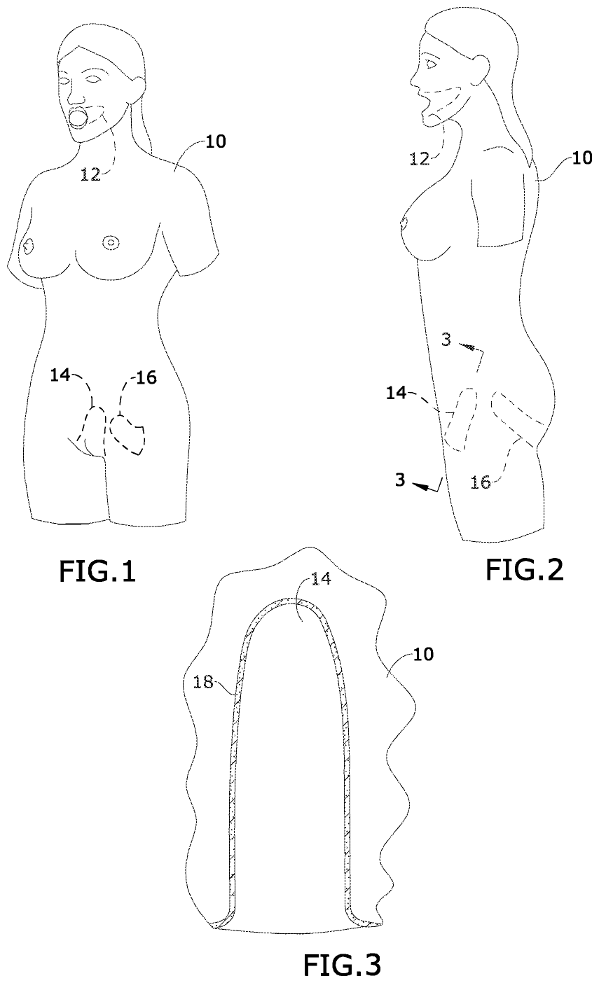

Referring now to FIGS. 1-3, an adult device 10 (depicted as a sex doll) is shown. As part of the larger device 10, it may have one or more specific contact surface portions that are intended for the male genitalia to contact or be inserted into. In the illustrated embodiment, the adult device has a first contact surface 12 portion (oral cavity), a second contact surface portion 14 (vaginal cavity), and a third contact surface portion 16 (anal cavity).

The entire device 10 may be formed from TPE, or only certain portions may be formed with TPE. Advantageously, these contact surface portions 14, 16, 18 may all be formed with a silver impregnated TPE material, preventing bacteria buildup on these portions. Ideally, the entire adult device 10 would be formed from the silver-infused material. However, by at least forming the contact surface portions 12, 14, 16 from the novel material, the risk of the end-user experiencing health issues from bacteria (and other organisms) growth is thereby reduced.

In use, the adult device 10 operates as normally intended (a sexually stimulating device). The user simply uses it as any other adult device would be used, with fewer cleaning/sanitization requirements due to the use of silver with the TPE. The present invention even makes it possible to sell the adult device 10 second-hand, which is something not currently possible for sanitary reasons.

As those with skill in the art will appreciate, such contact surface portions exist with adult devices intended for use with female genitalia, and the teachings of the present invention may be easily applied to those contact surface portions as well. The illustrated embodiment is merely intended to demonstrate one way to practice the invention, and it may result in many different final forms and products, such as other sex toys (e.g., dildo or vibrator), differently formed sex dolls, children's products that will be less prone to bacteria buildup, and other surfaces that include TPE as a material. By way of example, the present invention may be applied to children's toys or children's cups where bacterial and/or mold growth and buildup is a possibility.

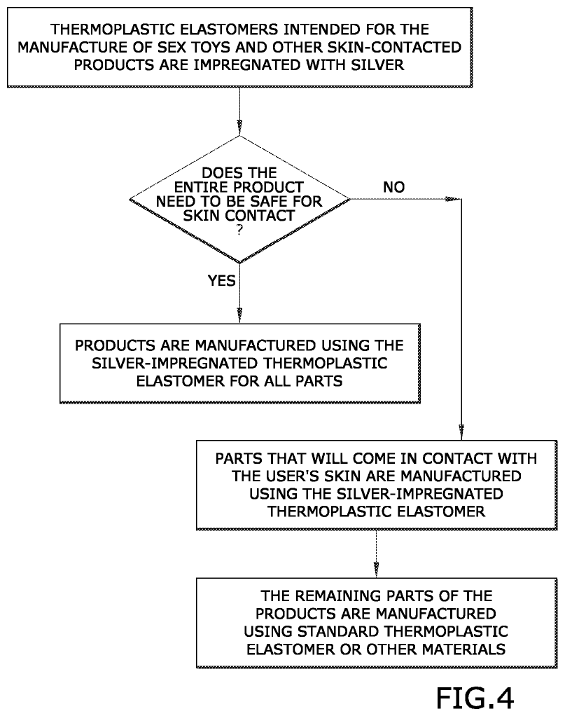

A method of manufacturing embodiments of the present invention is generally shown in FIG. 4. TPEs intended for the manufacture of adult devices and other products that contact the skin are impregnated with silver. Depending on the specific end-product desired, this may be achieved using slightly different manufacturing processes. For example, a silver nanopowder can be formed and mixed into a TPE batch. A Nanochemistry Research article published in 2016 and entitled “Antibacterial ethylene propylene rubber impregnated with silver nanopowder: AgNP@EPR” describes the production of silver-impregnated rubber and is incorporated herein by reference. A similar process as described in that article may be used to create the TPE impregnated with silver as described herein.

Once the TPE and silver composite has been formed, its application will depend on whether the entire product needs to be safe for skin contact or not. If the product does, all the parts of the product are manufactured using the silver-impregnated TPE material. If it is not important for all the parts to be bacteria-resistant, the parts that will regularly come into skin contact of the user (or are otherwise prone to bacteria growth) are manufactured with the silver-impregnated TPE, while other parts of the product are formed using standard TPE or other materials.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. An adult device comprising a first contact surface portion that is formed from a silver impregnated thermoplastic elastomer material.

2. The adult device of claim 1, further comprising: a second contact surface portion that is formed from the silver impregnated thermoplastic elastomer material.

3. The adult device of claim 2, further comprising: a third contact surface portion that is formed from the silver impregnated thermoplastic elastomer material.

4. The adult device of claim 2, wherein the adult device is a sex doll.

5. The adult device of claim 1, wherein a remainder of the adult device is formed from a material other than the silver impregnated thermoplastic elastomer material.

6. The adult device of claim 1, wherein an entirety of the adult device is formed from the silver impregnated thermoplastic elastomer material.

7. The adult device of claim 1, wherein the silver impregnated thermoplastic elastomer material comprises a silver nanopowder and a thermoplastic material that are mixed together.
